(19) United States
(12) Patent Application Publication
(10) Pub. No.: US 2023/0198916 A1
(43) Pub. Date: Jun. 22, 2023

(54) OPTIMIZATION OF INTERNET DATA RESOURCES

(71) Applicant: International Business Machines Corporation, Armonk, NY (US)

(72) Inventors: Sushain Pandit, Austin, TX (US); Sarbajit K. Rakshit, Kolkata (IN)

(21) Appl. No.: 17/555,259

(22) Filed: Dec. 17, 2021

(51) Int. Cl. H04L 47/762; H04L 43/0888; H04L 47/70; H04L 47/80

(52) U.S. Cl. CPC H04L 47/762; H04L 43/0888; H04L 47/822; H04L 47/805

(57) ABSTRACT

A processor may receive internet data information associated with a user and one or more internet activities performed on one or more devices. The one or more devices may be associated with a surrounding area. The processor may analyze internet data information. The processor may generate an internet data consumption plan. The internet data consumption plan may include one or more recommendations that optimize internet data consumption associated with the one or more internet activities. The processor may dynamically switch at least one of the one or more internet activities between an initial mode and one or more alternative modes. Dynamically switching between the initial mode and the one or more alternative modes is based on the internet data consumption plan.

### BACKGROUND

The present disclosure relates generally to the field of managing devices that utilize the internet to perform one or more purposes.

The internet acts as a bottomless source of data that can be used for a plethora of purposes. As user access to the internet has increased over the past few decades so too has the various ways in which user may interact and benefit from such access. Users can now view media (e.g., sporting events, news programing, television programs), keep in touch with friends and family using video chat, and receive educational course material, in a manner that would not be possible without the internet.

### SUMMARY

Embodiments of the present disclosure include a method, computer program product, and system for managing an one or more devices in a smart environment. A processor may receive internet data information associated with a user and one or more internet activities performed on one or more devices. The one or more devices may be associated with a surrounding area. The processor may analyze internet data information. The processor may generate an internet data consumption plan. The internet data consumption plan may include one or more recommendations that optimize internet data consumption associated with the one or more internet activities. The processor may dynamically switch at least one of the one or more internet activities between an initial mode and one or more alternative modes. Dynamically switching between the initial mode and the one or more alternative modes is based on the internet data consumption plan.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of an embodiment of an internet data management system, in accordance with the present disclosure.

FIG. 2 illustrates a flowchart of a method for managing internet data consumption, in accordance with embodiments of the present disclosure.

FIG. 3A illustrates a cloud computing environment, in accordance with embodiments of the present disclosure.

FIG. 3B illustrates abstraction model layers, in accordance with embodiments of the present disclosure.

FIG. 4 illustrates a high-level block diagram of an example computer system that may be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The present disclosure relates generally to the field of managing devices that utilize the internet to perform one or more purposes. While the present disclosure is not necessarily limited to such applications, various aspects of the disclosure may be appreciated through a discussion of several examples using this context.

Many internet providers offer wireless broadband internet data plans that only provide customers (e.g., users) with a fixed amount of internet data. These traditional internet data plans usually have an internet data threshold that allows customers to utilize the internet at a particular internet bandwidth speed until the user consumes an amount of internet data that meets and/or exceeds the internet data threshold. Once this internet data threshold is met and/or exceeded, the internet provider will often significantly reduce the internet bandwidth speed available to the customer. There can be a variety of different types of internet data consumption. For example, users can watch movies, attend online classes, forward images and/or videos through various applications, watch online news programs, internet browsing, and various other video media. Each of these aforementioned examples may result in different amounts internet data consumption. In addition, there can be multiple users (e.g., users within a household and/or office building) simultaneously consuming internet data under the same internet data plan.

Users may not have a problem consuming internet data during the initial portion of the fixed internet data plan, when there is still a significant amount of internet data remaining (e.g., the internet data has not reached the internet data threshold). Unfortunately, the problem with fixed internet data plans arises when internet data is not consumed and managed properly and the internet data threshold is met/or exceeded before the start of the next internet data allotment cycle. In such situations, users may encounter issues consuming internet data and will not be able to perform various internet activities because of insufficient bandwidth speeds.

As such, solutions are provided in the form of a method, system, and computer program product, for managing and/or optimizing internet data consumption based on available internet data within a fixed internet data plan. More particularly, solutions may generate an internet consumption plan (e.g., using AI and cognitive computing techniques) based, at least in part, on actual internet data consumption (e.g., internet data consumed by a user), modifying the internet data plan, issuing a user alerts and suggested proactive actions. By effectively managing internet data consumption, as contemplated herein, users will be able to continue to consume internet data throughout the fixed internet data plan in a more optimal manner, in such a way that reduces or minimizes the likelihood a user's experience will be diminished (e.g., by reduced bandwidth speeds).

Before turning to the FIGs. it is noted that the benefits/novelties and intricacies of the proposed solution are that:

The internet data management system may be identifying specific internet activities that can be performed in an alternate manner, by analyzing the surrounding area context information (e.g., internet data information) and user's needs. The internet data management system may then seamlessly dynamically switch between the internet activities consuming data with an alternat approach that reduces internet data consumption. This reduction in internet data consumption may result in an amount of internet data that can be saved for specific internet activities (e.g., internet activities that the user considers important). For example, if a user opens up a URL (e.g., information associated with the location of a web resources in a computer network) on a laptop to watch a live news sport program online (e.g., internet activity), internet data management system may identify whether the news or sport program can be shown on the user's television as well (e.g., using the user's cable subscription and not consuming internet data). If the internet data management system identifies that the program can be shown on the user's television, then the internet data management system may be configured to dynamically switch the program (e.g., internet activity) from the laptop (e.g., initial mode) to the television (e.g., alternative mode). In some embodiments, this may be based on the contextual situation. Alternatively, if internet data management system determines that during that time the television is already engaged by another user or the program is not available on the television, the internet data management system may show the news or sports program on the laptop and consume internet data instead.

If any internet activity is running in the background of a device and not on the active screen of the device (e.g., screen window the user is currently interacting with) then the internet data management system may analyze the user's needs and determine how internet data consumption may be reduced. For example, where a user is listening to the audio of a video streaming (e.g., internet activity) in the background, internet data management system may reduce the resolution of the image or video associated with the internet activity may be reduced or the audio may be switched, in a seamless manner, to a device that only provides the audio of the video to the user.

Based on user preference and/or historical learning (e.g., using AI and machine learning capabilities) on context information (e.g., different types of internet activities) collected from the surrounding area, the internet data management system may predict which internet activities are important to the user (e.g., internet activities that enhance the cognitive state or efficiency of the user(s)). The internet data management system may then generate a budget for those internet activities that are considered to be important to the user, to ensure there is a sufficient amount of internet data allocated for them. For example, the internet data management system may identify which attributes of the internet activity may enhance or improve the user's cognitive state and/or efficiency. Based on these attributes, the internet data management system may generate a budget and allocate an amount of internet data consumption associated with each of those attributes and particular internet activities.

Based on various types of internet activities, the internet data management system may generate predictions regarding what quality is to be maintained for a particular internet activity. Often, the higher quality required for an internet quality the greater the internet data consumption. Such predictions may enable the optimization of internet data consumption. Notifications can be sent to a user regarding the recommended quality of internet activity. For example, different types of internet activities may consume different amounts of internet data. The internet data management system will ensure the quality of some internet activities are maintained while other internet activities may have a reduced amount of interne data consumption. Such embodiments allow consumption of internet data to be optimized. Whether the internet activities is one that will have the quality reduced or an internet activity that will have the quality maintained may be determined using a historical data analysis. In such embodiments, the user may be notified if there is a change in quality.

Based on the remaining amount of available internet data (e.g., of the total internet data allotted under the fixed internet data plan) and the pending activities planned for the remaining time duration (e.g., weeks, days, hours, etc.) of the current internet data cycle, the internet data management system may generate notifications to the user regarding different internet activities and/or amounts of internet data consumption to ensure the user is able to receive the required level (e.g., quality) of user experience while performing internet activities that may be considered priority internet activities. For example, if the internet data management system determines the user does not have enough internet data for the remaining amount of time on the fixed internet data plan cycle, then based on the particular type of internet activity (e.g., forwarding large non-essential files to a group, opening any large file, playing a high pixel rate video, etc.) the internet data management system may send the user notifications regarding what internet activities, if stopped performing, can optimize internet data consumption to ensure there is sufficient internet data (e.g., sufficient bandwidth speed to maintain user experience) for internet activities the user has prioritized (e.g., high user priority level).

Based on the available internet data, as identified in the fixed internet data plan, the internet data management system identify if there are files to be transferred among multiple users within the same location (e.g., within the same household or office). The internet data management system may then be configured to dynamically enable an alternat mode of file transfer among the users within the same location in order to reduce internet data consumption. For example, if the user wants to share a video on a social media application, the internet data management system may validate the proximity of the various users and amount of internet data available for consumption, then the internet data management system may transfer the video through Bluetooth instead of the internet to conserve internet data.

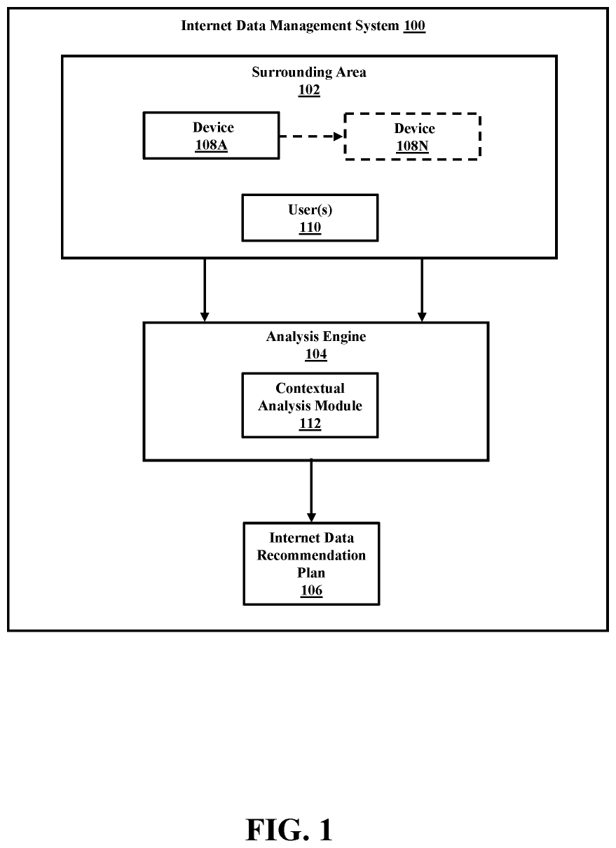

Referring now to FIG. 1, illustrated is a block diagram of an example internet data management system 100, in accordance with aspects of the present disclosure, for managing and/or optimizing internet data consumption. As depicted, internet data management system 100 may include surrounding area 102, analysis engine 104, and internet data consumption plan 106. In embodiments, surrounding area 102 may be any area having one or more devices 108A-N associated with one or more users 110 that may be provided internet services under an internet data plan from an internet service provider. As contemplated herein, internet service providers may provide users with fixed amounts of internet data that if not managed properly will often result in diminished user experience as the user consumes internet data that exceeds an internet data threshold. In embodiments, surrounding area 102 may be associated with an fixed internet data plan having a fixed amount of internet data users 110 may consume during a particular time duration (e.g., a quarter, month, or week). Surrounding area 102 may include any area or particular structure (e.g., house, building, etc.) that may receive internet from the fixed internet data plan.

In embodiments, internet data management system 100 may be configured to receive internet data information associated with user 110 and one or more internet activities performed on one or more devices 108A-N (e.g., laptop, television, smart devices etc.). One or more devices 108A-N may include any device or smart device within surrounding area 102 that may be configured to interact with the internet data management system 100. In some embodiments, Internet of Things (IoT) feeds may be configured in one or more devices 108A-N. While in embodiments, one or more devices 108A-N may be associated with surrounding area 102 (e.g., devices 108A-N are configured within the surrounding area 102), in other embodiments, one or more devices 108A-N may be mobile (e.g., mobile phone or laptop) and may enter or exit surrounding area 102 with user 110. While embodiments contemplated herein often make reference to a single user, user 110 may be representative of any number of users that may be consuming internet data associated with surrounding area 102.

In embodiments, internet data information may include information associated the types of devices that comprise one or more devices 108A-N, the types of internet activities performed on the one or more devices 108A-N, the quality (e.g., higher or lower image and/or video resolution), information associated with user 110 (e.g., context information), URL information (e.g., information associated with the location of a web resources in a computer network), data generated as a result of any of the analyses contemplated herein (e.g., patterns identified by analyzing historical internet data from the historical repository). In embodiments, internet data management system 100 may be configured to collect and store internet data information collected over time in a historical repository (not depicted in FIG. 1).

In embodiments, internet data management system 100 may be configured to analyze this information using analysis engine 104. Analysis engine 104 may be configured with AI and machine learning capabilities to perform any analyses contemplated herein. In such embodiments, analysis engine 104 may be configured to access historical internet data information from the historical repository to identify one or more historical patterns associated with user 110 consuming internet data. From these historical patterns, analysis engine 104 may identify types of internet activities, duration of internet activities, quality (e.g., resolution) the user has historically perceived internet activities, user 110's level of attention (e.g., user priority level) given to various internet activities. Internet activities may include, but are not limited to, activities utilizing the internet data, such as streaming movies, attending online coursework, forwarding and sending images and/or videos via social media applications, streaming online news, and watching videos. More particularly, analysis engine 104 may classify internet activities as avoidable activities (e.g., accidental streaming a video), unavoidable non-essential activities (e.g., social media, watching video clips), and unavoidable essential activities (e.g., work meetings, online classes, video calls, streaming movies).

In some embodiments, analysis module 104 may include contextual analysis module 112. In these embodiments, contextual analysis module 112 may perform a contextual analysis on the identified internet activities and associated internet data information. Contextual analysis module 112 may be configured to analyze internet data information, such as that provided by IoT feeds associated with some or all of one or more devices 108A-N. Contextual analysis module 112 may use the results of these analyses to determine the various capabilities of the one or more devices 108A-N. These capabilities may include, but are not limited to identifying which of the one or more devices 108A-N can perform different types of the one or more internet capabilities. Using this information, analysis engine 104 may be configured to determine if the internet activities can be provided to user 110 in an alternative mode or manner. An alternative mode may include displaying or providing the internet activity on a different device (e.g., one or more devices 108A-N) or source (e.g., a source that would not consume internet data) that is different from the initial mode user 110 initiated the internet activity.

For example, instead of streaming a news program on the user's laptop that consumes internet data, analysis engine 104 may determine that the news program could be alternatively provided to user 110 through the use of the user 110's television satellite device. In some embodiments, analysis engine 104 may determine user 110's proximity to devices 108A-N. In these embodiments, devices 108A-N that are determined to be proximate to user 110, such as those configured with Bluetooth capabilities or other near-proximity alternative devices, may be used as an alternative mode (e.g., for file/data sharing). In embodiments, the alternative mode would result in a reduction of internet data consumption when compared to the initial mode (e.g., device or source the user initiated the internet activity through). In some embodiments, analysis engine 104 may be configured to analyze URL information (e.g., internet data information) to identify one or more alternative modes the contents of the URL (e.g., internet activity) may be provided to user 110.

In embodiments where internet data management system 100 identifies one or more alternative modes the internet activity can be provided to user 110, internet data management system 100 may identify (e.g., using analysis engine 104) if the alternative mode, such as one of the one or more devices 108A-N, is available and not in use by user 110 (e.g., or another user within the surrounding environment). For example, if internet data management system 100 identifies a device 108A-N, such as a television, that may act as an alternative mode for streaming a movie, internet data management system 100 may be able to determine that user 110 or another user withing the surrounding area 102 is using the television for another purpose. In this example, the television would be unavailable and could not act as a valid alternative mode. In such embodiments, where internet data management system 100 identifies that an alternative mode is not available, internet data management system 100 may attempt to identify another alternative mode that is available or continue using the initial mode to execute the internet activity (e.g., play the video URL on the original device 108A-N). If internet data management system 100 does identify that the alternative mode is available, then internet data management system 100 may seamlessly transfer the internet activity from the initial mode to the available alternative mode. In such embodiments, the alternative mode will be executing the same internet activities in a different manner using the alternative mode.

In embodiments, internet data management system 100 may be configured, using contextual analysis module 112 of analysis engine 104, to identify a user priority level associated with particular internet activities. A user priority level indicates what types of internet activities and/or internet activity attributes are important or relevant to user 110. An internet activity attribute may include, but is not limited to, the type of media the user is interacting with (e.g., video, video subtitles, audio, etc.) and quality of the internet activity (e.g., resolution of the image/video, or audio noise). In such embodiments, analysis engine 104 may access internet data information stored in the historical repository and analyze (e.g., using AI and machine learning capabilities) to identify the user priority level of the particular internet activity. For example, user 110 may be listening to music on one webpage while directly interacting with another webpage or application. In this example, contextual analysis module 112 could identify that user 110 is using the music webpage as a source of background music and that the webpage user 110 is directly interacting with is more important to user 110.

In embodiments, analysis engine 104 (e.g., using contextual analysis module 112) may analyze context information (e.g., internet data information) associated with user 110 and internet activity to determine how the user is observing the internet activity. Continuing the example embodiment, contextual analysis module 112 may be configured to identify that user 110 is listening to the audio of the music webpage (e.g., internet activity) but is not observing image or video content associated with the internet activity. In other words, contextual analysis module may identify that the webpage the user is directly interacting with has a high user priority level when compared to the music webpage in the background. In addition, contextual analysis module 112 may determine that the user is only listening to the music webpage and is not interacting/observing any images or videos associated with the music webpage. As such, contextual analysis module 112 may identify that user 110 considers the audio or music associated with the music webpage to have a high user priority level while any image or content associated with the music webpage has a low user priority level.

In embodiments where contextual analysis module 112 has identified a low user priority level, internet data management system 100 may identify an alternative mode that may conserve internet data by reducing the amount of internet data consumed performing the low user priority level. In such embodiments, internet data management system 100 may identify an alternative mode, such as one of one or more devices 108A-N, where only the audio or relevant media type (e.g., audio and not video) of the internet activity can be played. In embodiments where internet data management system 100 is unable to identify another device (e.g., one or more devices 108A-N in surrounding area 102) where the low user priority level internet activity can be implemented on, internet data management system 100 may be configured to alter the internet activity attributes to reduce the amount of internet data consumption without minimizing the user 110′s experience. Continuing the above example, if internet data management system 100 is unable to locate a device configured to play audio, internet data management system 100 may continue to play the music on the webpage (e.g., internet activity) using the original device (e.g., a type of one or more devices 108A-N) but may reduce the internet data consumption by reducing the resolution of the image or video associated with the music. By reducing the various media types of the internet activity (e.g., attributes), internet data management system 100 can ensure the user can consume or execute the various internet activities as they intend while also reducing the amount of internet data that would otherwise be consumed. The resulting internet data consumption may be saved for another internet activity in the future.

In embodiments, internet data management system 100 may be configured to prioritize or rank the one or more internet activities observed in surrounding area 102. The one or more internet activities may be ranked based on user priority level associated with each of the internet activities. Contextual analysis module 112 may be configured to identify a user priority level by analyzing internet data information (e.g., context information), such as that stored in the historical repository, to identify a user priority level for each internet activity as it relates correlates to a user 110's needs. In such embodiments, the more important the need is to user 110, the higher the user priority level. Contextual analysis module 112 may also consider whether the internet activity improves user 110's cognitive state. In these embodiments, contextual analysis module 112 may, in addition to user 110's needs, consider how the internet activity affects user 110's cognitive state (e.g., user 110 productivity at work). Those internet activities determined to improve user 110's cognitive state may be assigned a higher user priority level while those that reduce or do not improve a user 110's cognitive state, may be assigned a lower user priority level. In some embodiments, internet data management system 100 may be configured to receive input from user 110 associated with how internet activities may be assigned a user priority level.

In embodiments, internet data management system 100 may be configured to generate a budget for each of the one or more internet activities. In these embodiments, internet data management system 100 may assign an internet data consumption limit for each of the one or more internet activities. The amount of available consumable internet data utilized by the budget may be based on identifying the amount of internet data associated with the fixed internet data plan. The internet data consumption limits for each internet activity within the budget may be based, at least in part, on user priority levels associated with each of the one or more internet activities. For example, internet data management system 100 may budget/allocate a higher internet data consumption amount (or limit) for internet activities having a higher ranked user priority level and budget/allocate a lower internet data consumption amount for internet activities having a lower user priority level. For example, an internet activity that is determined to boost user 110's cognitive state, resulting in a high user priority level, may be allocated a higher amount of internet data to consume.

In some embodiments, analysis engine 104 may be configured to analyze internet data information to predict an amount of internet data that may be consumed (e.g., an amount of internet data consumption) by each of the one or more internet activities. In some embodiments, analysis engine 104 may be predict how much internet data may be consumed using historical internet data (e.g., from the historical repository) and using user priority levels and AI and machine learning techniques to identify different patterns (e.g., internet data information) associated with user 110's internet data usage. Using predictions generated by analysis engine 104, internet data management system 100 may generate a more accurate a budget for each of the one or more internet activities. In some embodiments, the aforementioned predictions may be used to indicate whether user 110 will have sufficient internet data to perform the one or more activities. In such embodiments, internet data management system 100 may issue a notification to user 110 indicating user 110 should increase the amount of internet data allotted by the internet service provider in their fixed internet data plan.

In embodiments, internet data management system 100 may generate one or more notifications to user 110. These notifications may include updates regarding the amount of internet data consumption is occurring at a particular time in surrounding area 102 while the one or more internet activities are executed. In some embodiments, internet data management system 100 may base the notification based on the user priority level of the internet activity. For example, fewer notifications may be issued for internet activities having lower user priority levels while internet activities having higher user priority levels may issue multiple notification to user 110 to ensure user 110's experience with the internet activity is not minimized by reduced bandwidth speeds.

In embodiments, internet data management system 100 may be configured to generate internet data recommendation plan 106. In some embodiments, internet data recommendation plan 106 may be provided to user 110 and include one or more recommendations associated with how the fixed amount of internet data provided in the fixed internet data plan may be optimally managed throughout the cycle of allotted internet data. Internet data recommendation plan 106 may include any analysis result generated by analysis engine 104 and/or contextual analysis module 112. For example, internet data recommendation plan 106 may include how the user may minimize and conserve internet data to ensure there is sufficient internet data remaining to sufficiently supply internet activities to the user having a high user priority level without minimizing the user's experience (e.g., surpassing the internet data threshold and having a reduced bandwidth speed).

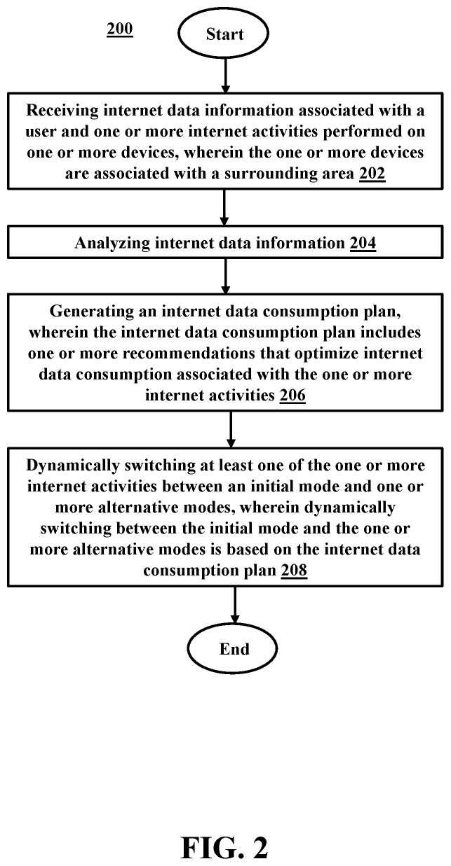

Referring now to FIG. 2, illustrated a flowchart of an example method 200 for managing (e.g., optimizing) internet data consumption, in accordance with aspects of the present disclosure. In some embodiments, the method 200 may be performed by a processor (e.g., of the internet data management system 100 of FIG. 1, etc.).

In some embodiments, the method 200 may begin at operation 202. At operation 202 the processor receives internet data information associated with a user and one or more internet activities performed on one or more devices, wherein the one or more devices are associated with a surrounding area.

In some embodiments, the method 200 may proceed to operation 204, where the processor analyzes internet data information (e.g., using AI and machine learning capabilities). In embodiments, such analysis may include contextual analysis to identify how (e.g., types of internet activities) users are consuming internet data and assigning a user priority level to each of the internet activities. In some embodiments, such an analysis may also include historical analyses using internet data stored in a historical repository to identify patterns in a user's use of internet data.

In some embodiments, the method 200 proceeds to operation 206. At operation 206, the processor generates an internet data consumption plan. In some embodiments, the internet data consumption plan includes one or more recommendations that optimize internet data consumption associated with the one or more internet activities.

In some embodiments, the method 200 may proceed to operation 208. At operation 208, the processor dynamically switches at least one of the one or more internet activities between an initial mode and one or more alternative modes. In some embodiments, a processor may base dynamically switch between the initial mode and the one or more alternative modes on the internet data consumption plan.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

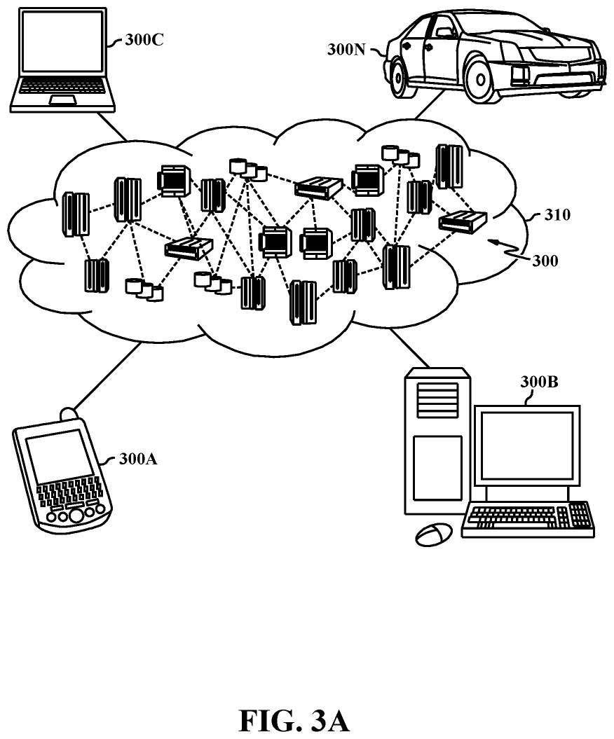

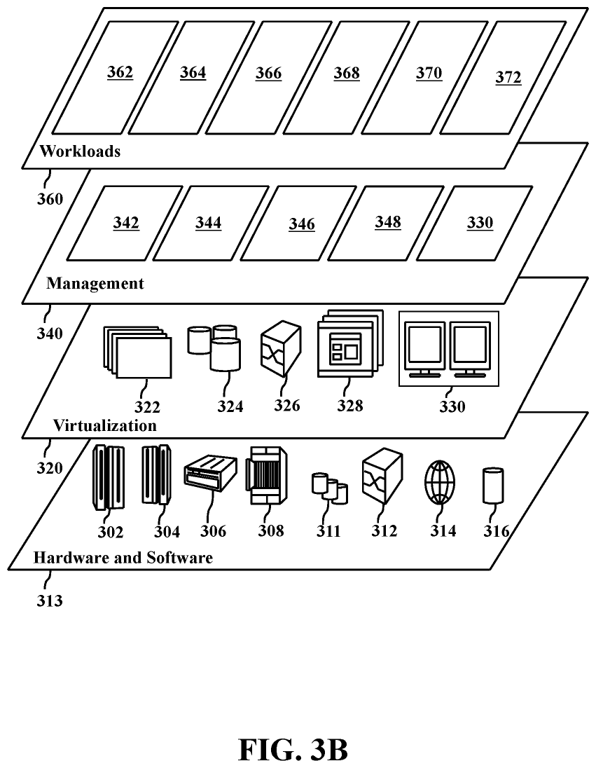

Referring now to FIG. 3A, illustrative cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof. This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing 300 and cloud computing environment 310 can communicate with any type of computerized device over any type of network and/or network addressable connection (e.g., using a web browser).

Referring now to FIG. 3B, a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and internet data managing 372.

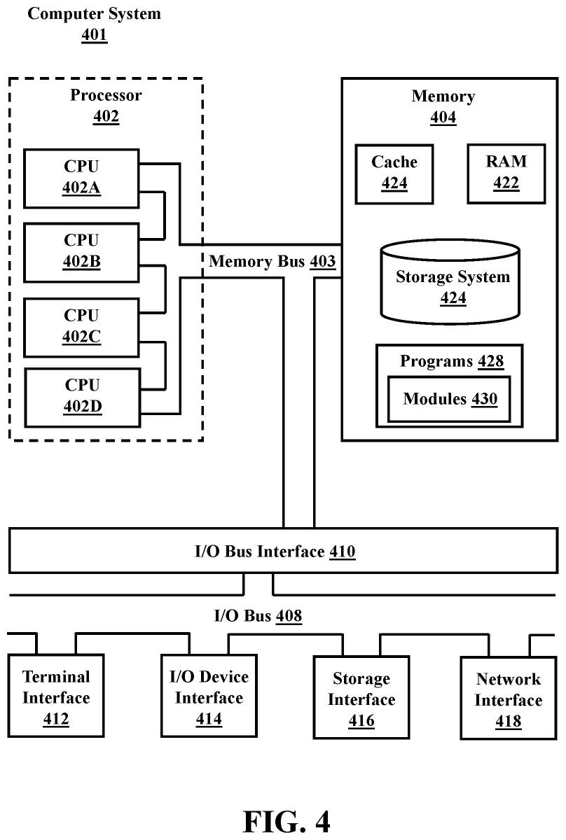

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present invention. In some embodiments, the major components of the computer system 401 may comprise one or more Processor 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A method of managing internet data consumption, the method comprising:
receiving, by a processor, internet data information associated with a user and one or more internet activities performed on one or more devices, wherein the one or more devices are associated with a surrounding area;
analyzing internet data information;
generating an internet data consumption plan, wherein the internet data consumption plan includes one or more recommendations that optimize internet data consumption associated with the one or more internet activities; and
dynamically switching at least one of the one or more internet activities between an initial mode and one or more alternative modes, wherein dynamically switching between the initial mode and the one or more alternative modes is based on the internet data consumption plan.

2. The method of claim 1, further comprising:
predicting an amount of internet data consumption for each of the one or more internet activities, based on internet data information; and
generating a budget for each of the one or more internet activities, wherein the budget includes an internet data consumption limit for each of the one or more internet activities.

3. The method of claim 1, wherein analyzing internet data includes:
determining whether at least one of the one or more internet activities have at least one of the one or more alternative modes, wherein the one or more alternative modes have a reduced amount of internet data consumption than the initial mode.

4. The method of claim 1, wherein analyzing internet data includes:
performing a contextual analysis on the internet data information; and
identifying a user priority level from the contextual analysis for one or more internet activities.

5. The method of claim 4, further including:
analyzing the one or more internet activities and the user priority level; and
identifying an amount of internet data consumption for the at least one of the one or more internet activities based on the user priority level.

6. The method of claim 5, further including:
ranking the one or more internet activities based on the user priority level associated with each of the one or more internet activities; and
generating a budget for each of the one or more internet activities, the budget having an internet data consumption limit for each of the one or more internet activities, wherein a higher ranked user priority level is assigned a higher internet data consumption limit than a lower user priority level.

7. The method of claim 1, wherein dynamically changing the at least one of the one or more internet activities between the initial mode and the one or more alternative modes further includes switching between the one or more devices.

8. A system for managing internet data consumption, the system comprising:
a memory; and
a processor in communication with the memory, the processor being configured to perform operations comprising:
receiving internet data information associated with a user and one or more internet activities performed on one or more devices, wherein the one or more devices are associated with a surrounding area;
analyzing internet data information;
generating an internet data consumption plan, wherein the internet data consumption plan includes one or more recommendations that optimize internet data consumption associated with the one or more internet activities; and
dynamically switching at least one of the one or more internet activities between an initial mode and one or more alternative modes, wherein dynamically switching between the initial mode and the one or more alternative modes is based on the internet data consumption plan.

9. The system of claim 8, further comprising:
predicting an amount of internet data consumption for each of the one or more internet activities, based on internet data information; and
generating a budget for each of the one or more internet activities, wherein the budget includes an internet data consumption limit for each of the one or more internet activities.

10. The system of claim 8, wherein analyzing internet data includes:
determining whether at least one of the one or more internet activities have at least one of the one or more alternative modes, wherein the one or more alternative modes have a reduced amount of internet data consumption than the initial mode.

11. The system of claim 8, wherein analyzing internet data includes:
performing a contextual analysis on the internet data information; and
identifying a user priority level from the contextual analysis for one or more internet activities.

12. The system of claim 11, further including:
analyzing the one or more internet activities and the user priority level; and
identifying an amount of internet data consumption for the at least one of the one or more internet activities based on the user priority level.

13. The system of claim 12, further including:
ranking the one or more internet activities based on the user priority level associated with each of the one or more internet activities; and
generating a budget for each of the one or more internet activities, the budget having an internet data consumption limit for each of the one or more internet activities, wherein a higher ranked user priority level is assigned a higher internet data consumption limit than a lower user priority level.

14. The system of claim 8, wherein dynamically changing the at least one of the one or more internet activities between the initial mode and the one or more alternative modes further includes switching between the one or more devices.

15. A computer program product for managing internet data consumption comprising a computer readable storage medium having program instructions embodied therewith, the program instructions executable by a processor to cause the processor to perform operations, the operations comprising:
receiving internet data information associated with a user and one or more internet activities performed on one or more devices, wherein the one or more devices are associated with a surrounding area;
analyzing internet data information;
generating an internet data consumption plan, wherein the internet data consumption plan includes one or more recommendations that optimize internet data consumption associated with the one or more internet activities; and
dynamically switching at least one of the one or more internet activities between an initial mode and one or more alternative modes, wherein dynamically switching between the initial mode and the one or more alternative modes is based on the internet data consumption plan.

16. The computer program product of claim 15, further comprising:
predicting an amount of internet data consumption for each of the one or more internet activities, based on internet data information; and
generating a budget for each of the one or more internet activities, wherein the budget includes an internet data consumption limit for each of the one or more internet activities.

17. The computer program product of claim 15, wherein analyzing internet data includes:
determining whether at least one of the one or more internet activities have at least one of the one or more alternative modes, wherein the one or more alternative modes have a reduced amount of internet data consumption than the initial mode.

18. The computer program product of claim 15, wherein analyzing internet data includes:
performing a contextual analysis on the internet data information; and
identifying a user priority level from the contextual analysis for one or more internet activities.

19. The computer program product of claim 18, further including:
analyzing the one or more internet activities and the user priority level; and
identifying an amount of internet data consumption for the at least one of the one or more internet activities based on the user priority level.

20. The computer program product of claim 19, further including:
ranking the one or more internet activities based on the user priority level associated with each of the one or more internet activities; and
generating a budget for each of the one or more internet activities, the budget having an internet data consumption limit for each of the one or more internet activities, wherein a higher ranked user priority level is assigned a higher internet data consumption limit than a lower user priority level.
